(19) United States
(12) Patent Application Publication
(10) Pub. No.: US 2026/0282148 A1
(43) Pub. Date: Sep. 17, 2026

(54) USER EQUIPMENT DRIVEN BEAM PAIR UPDATE IN NEW RADIO

(71) Applicant: APPLE INC., Cupertino, CA (US)

(72) Inventors: Kenan Kocagoez, Fuerth (DE); Cen Lin, Irvine, CA (US); Flavio De Angelis, San Diego, CA (US); Yakun Sun, San Jose, CA (US); Amir Aminzadeh Gohari, Sunnyvale, CA (US); Yeong-Sun Hwang, Germering (DE); Carlo Tosetti, Munich (DE)

(21) Appl. No.: 19/078,881

(22) Filed: Mar. 13, 2025

(51) Int. Cl. H04W 76/20; H04B 7/06; H04B 17/309; H04B 17/318; H04L 5/00

(52) U.S. Cl. CPC H04W 76/20; H04B 7/06964; H04B 17/328; H04B 17/346; H04L 5/0051

(57) ABSTRACT

Methods and systems for user equipment (UE) drive beam pair updating in new radio are discussed herein. For example, a UE may generate active transmission configuration indication (TCI) state metrics corresponding to an active TCI state and non-active TCI state metrics corresponding to a plurality of non-active TCI states based on measurements performed on reference signals and synchronization signal blocks (SSBs) received from a base station and select a target TCI state based, in part, on comparing the active TCI state metrics and the non-active TCI state metrics. The UE may determine that the active TCI state metrics are less than a maximum metric value and, in response to the active TCI state metrics being less than the maximum metric value, proactively trigger, beam failure recovery (BFR) to switch from the active TCI state to the target TCI state before receiving TCI state configuration signaling.

### TECHNICAL FIELD

This application relates generally to wireless communication systems, including systems implementing beam recovery procedures.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR 2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a flow diagram of UE-triggered TCI state switching, according to embodiments herein.

FIG. 2 illustrates a method of a UE, according to embodiments herein.

FIG. 3 illustrates an example architecture of a wireless communication system, according to embodiments disclosed herein.

FIG. 4 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communication systems, various studies indicate that the success rate of beam failure recovery procedures defined by 3GPP is poor. For example, various times, beam failure detection (BFD) does not lead to beam recovery but instead leads to radio link failure (RLF). Thus, it may be beneficial to leverage beam failure recovery (BFR)-random access channel (RACH) mechanisms for UE-triggered transmission configuration indication (TCI) state switching due to various cases. In some cases, there may be a significantly better-quality (e.g., stronger) synchronization signal block (SSB) than the current active TCI state reference. It may be that the physical downlink shared channel (PDSCH) TCI states list is not configured. It may be that the physical downlink control channel (PDCCH) TCI states list is not configured. It may be that the physical uplink control channel (PUCCH) spatial relations list is not configured. It may be that the TCI state or spatial relation is not configured for a resource. For example, an aperiodic channel state information reference signal (AP-CSI-RS) (e.g., CSI-AssociatedReportConfigInfo) may be received without TCI state information (e.g., without qcl-info). Additionally, in scenarios using spatial relation, a TCI states chain may be broken, or tracking reference signal (TRS) resource sets are not configured.

Embodiments herein introduce methods for the UE to proactively steer active TCI state and/or spatial relation selection and switching (e.g., UE-triggered TCI state selection and switching). Note that currently such procedures are solely network controlled. As a result, embodiments herein may handle real life scenarios with non-network configured TCI states and may improve the performance of the UE in medium and high signal-to-noise (SNR) spectrums. Further, embodiments herein may enhance the beam recovery success rate in low SNR scenarios.

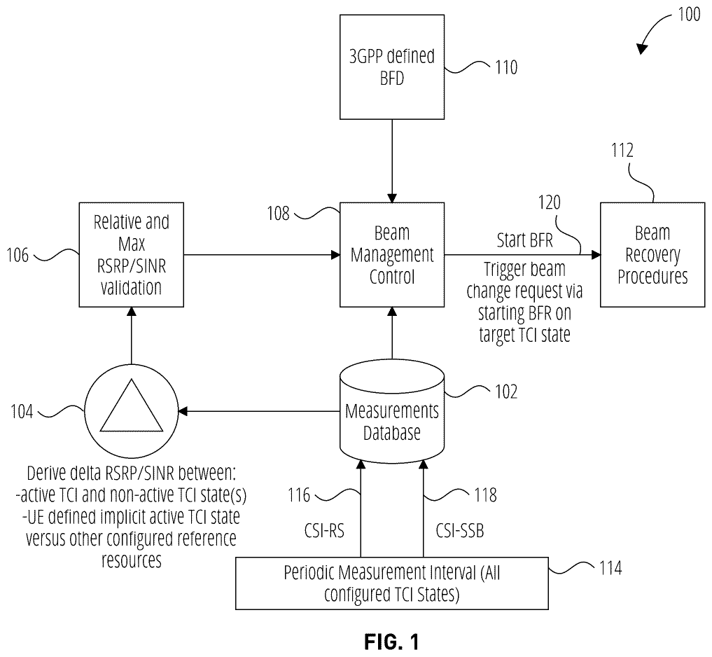

FIG. 1 illustrates a flow diagram 100 of UE-triggered TCI state switching, according to embodiments herein. In some embodiments, a UE-triggered TCI state switching procedure may be introduced leveraging various UE-based BFR-RACH mechanisms.

For example, the flow diagram 100 for UE-triggered TCI state switching includes the UE performing candidate beam detection (CBD) (e.g., as a background task). The CBD results (e.g., a reference signal received power (RSRP) metric calculation) may be stored in the measurements database 102. Additionally, the measured CSI-SSB 118 and CSI-RS 116 (e.g., for signal-to-interference-plus noise ratio (SINR) metric calculation) may be stored in the measurements database 102.

In some instances, the initial (e.g., first) active TCI state used to perform the measurements is configured by the network (e.g., a base station) through a configuration message (e.g., MAC CE). In some other instances, the initial (e.g., first) active TCI state used to perform the measurements is determined implicitly by the UE (e.g., the UE impoliticly determines an implicit TCI state). For example, the UE may use a FR2 primary secondary cell (PSCell) add/attach procedure, where an initial cell acquisition procedure measures all broadcasted SSBs of the target cell (e.g., FR2 target cell given initially via radio resource control RRC of the anchor cell (e.g., FR1/LTE)). The UE can select the strongest SSB as an initial implicit active TCI state, and can start performing a RACH procedure based on it before reception of the first MAC CE for TCI state activation. Note that in various scenarios, a MAC CE may not be received from or transmitted by the network. The implicit active TCI becomes the active TCI via the first MAC CE from the network (e.g., base station).

The implicit TCI state refers to a TCI state that is used by the UE prior to receiving a configuration from the network activating the implicit TCI state. After the implicit TCI state is activated, it may be referred to as an active TCI state. The UE may use the implicit TCI state before it becomes the active TCI state.

The UE may process the measured CSI-RS 116 and/or the CSI-SSB 118 to generate active TCI state metrics such as RSRP values, SINR values, and/or SNR if the active TCI state was used. The UE may also process the measured CSI-RS 116 and CSI-SSB 118 to generate non-active TCI state metrics such as RSRP values, SINR values, and/or SNR values corresponding to if the non-active TCI states were used.

Then, the UE can select a candidate target TCI state based on various determinations made by the UE using the stored values in the measurements database 102. In some cases, the UE may determine 104 an RSRP and/or SINR difference between the active TCI state (or implicit TCI state) used to perform measurement and other non-active TCI state(s). Accordingly, the UE may base its target TCI state selection based on which RSRP and/or SINR value is higher (e.g., between the active and non-active TCI states). For example, the non-active TCI state(s)'s CBD RSRP is compared to the active TCI state's CBD RSRP plus a delta RSRP value. The non-active TCI state(s)'s CSI-SSB and/or CSI-RS SINR is compared to the active TCI state's SINR plus a delta SINR value. Based on the comparisons, the UE may find one or more non-active TCI state(s) that are better (e.g., having a higher RSRP value or SINR value) as compared to the active TCI state.

The UE can select the strongest non-active TCI state among the eligible candidates found (if any), and declare it as the new candidate target TCI state. Note that if it is determined that the active TCI state is stronger than the non-active TCI states, the UE may reuse/keep using the active TCI state.

In some instances, the UE may validate 106 the calculated active TCI state RSRP value or SINR value using relative and maximum RSRP and/or SINR values before triggering the TCI state change via the BFR. This may be understood as a checking a pre-condition for the BFD. In some instances, the BFR (e.g., TCI state change) is triggered if the active TCI state SINR is less than an SINR_MAX and/or that the active TCI state RSRP is less than an SINR_MAX. The BFR (e.g., changing TCI state) is not triggered if the active TCI state SINR is greater than or equal to SINR_MAX and/or that the active TCI state RSRP is greater than or equal to RSRP_MAX. In such cases, an additional UE performance increase would not be achieved with a TCI state switch, as the active TCI state RSRP/SINR is sufficiently high. Such validation ensures that the BFR and change in TCI states results in a noticeable increase in UE performance. Note that UE performance may experience diminishing returns as it improves beyond a certain SINR and/or RSRP value (e.g., the configured SINR_MAX and RSRP_MAX).

For beam management control 108, BFD is triggered 110 as defined in 3GPP based on active TCI state (or implicit TCI state) block error rate (BLER) threshold crossings. In addition to the triggered 110 BFD or alternatively to the triggered 110 BFD, BFR is triggered 120 for the selected target TCI (e.g., selected according to the methods discussed herein). Beam recovery procedures 112 may be performed based on the triggered 120 BFR and/or based on the target TCI state (e.g., switching to the target TCI state). In some instances, the CSI-RS 116 and the CSI-SSB 118 stored in the measurements database 102 may be used for beam management control 108 and for the BFR procedure.

The same determinations and selection of a new/updated target TCI state may be repeated with every CSI-SSB 118 and/or CSI-RS 116 measured during the periodic measurement interval 114 to determine updated active and non-active TCI state metrics. Note that the newly measured CSI-RS 116 and CSI-SSB 118 are measured using the switched to target TCI state (e.g., the target TCI state selected in a previous iteration of the TCI state selection procedure) or the same active TCI state (e.g., if no non-active TCI state is better than the active TCI state). Based on the newly measured CSI-SSB 118 and CSI-RS 116 (e.g., the updated active and non-active TCI state metrics), target TCI state selection may be performed and it may be determined whether to switch or not to switch the active TCI state to a non-active TCI state. This process is repeated as needed (e.g., as determined by the UE).

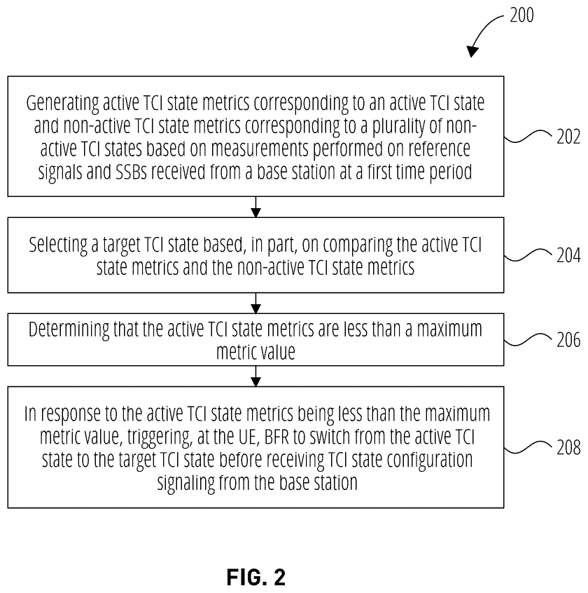

FIG. 2 illustrates a method 200 of a UE, according to embodiments herein. The illustrated method 200 includes generating 202 active TCI state metrics corresponding to an active TCI state and non-active TCI state metrics corresponding to a plurality of non-active TCI states based on measurements performed on reference signals and SSBs received from a base station at a first time period. The method 200 further includes selecting 204 a target TCI state based, in part, on comparing the active TCI state metrics and the non-active TCI state metrics. The method 200 further includes determining 206 that the active TCI state metrics is less than a maximum metric value. The method 200 further includes, in response to the active TCI state metrics being less than the maximum metric value, triggering 208, at the UE, BFR to switch from the active TCI state to the target TCI state before receiving TCI state configuration signaling from the base station (e.g., proactively triggering BFR).

In some embodiments, the method 200 further comprises generating updated active TCI state metrics and updated non-active TCI state metrics based on measurements performed according to the target TCI state on the reference signals and the SSBs received from the base station at a second time period.

In some embodiments of the method 200, selecting the target TCI state comprises in response to at least one of the non-active TCI state metrics being greater than the active TCI state metrics, selecting a strongest non-active TCI state of the plurality of non-active TCI states corresponding to the non-active TCI state metrics as the target TCI state.

In some embodiments of the method 200, the maximum metric value comprises a maximum RSRP value or a maximum SINR.

In some embodiments of the method 200, the active TCI state metrics comprise an RSRP value and an SINR.

In some embodiments of the method 200, the non-active TCI state metrics comprise an RSRP value and an SINR.

In some embodiments of the method 200, after triggering the BFR the active TCI state comprises an implicit TCI state, the method further comprising receiving, from the base station, a MAC CE message activating the implicit TCI state.

In some embodiments of the method 200, the implicit TCI state is determined by the UE according to the measurements performed on the reference signals and the SSBs.

In some embodiments, the method 200 further comprises performing BFD based on a BLER threshold crossing and the active TCI state metrics.

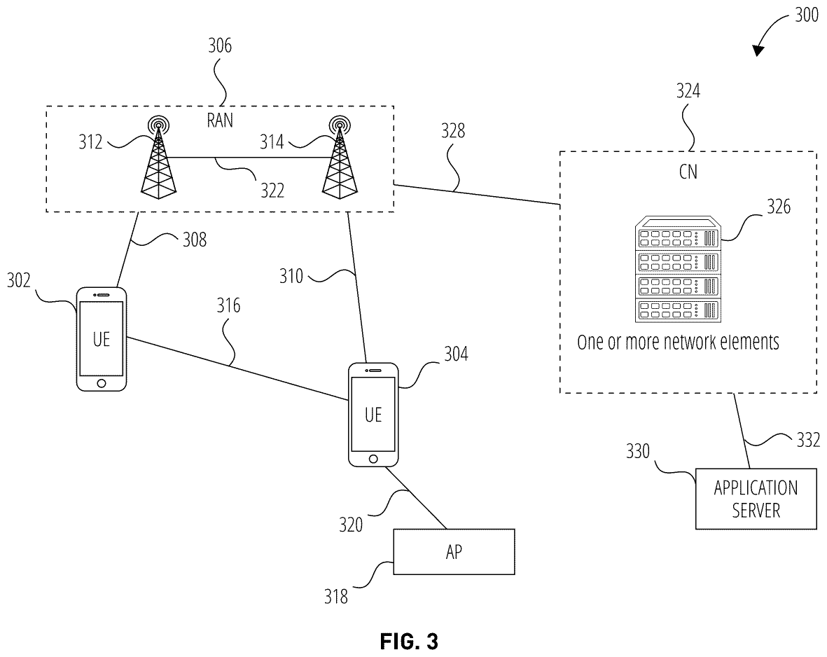

FIG. 3 illustrates an example architecture of a wireless communication system 300, according to embodiments disclosed herein. The following description is provided for an example wireless communication system 300 that operates in conjunction with the LTE system standards and/or 5G or NR system standards as provided by 3GPP technical specifications.

As shown by FIG. 3, the wireless communication system 300 includes UE 302 and UE 304 (although any number of UEs may be used). In this example, the UE 302 and the UE 304 are illustrated as smartphones (e.g., handheld touchscreen mobile computing devices connectable to one or more cellular networks), but may also comprise any mobile or non-mobile computing device configured for wireless communication.

The UE 302 and UE 304 may be configured to communicatively couple with a RAN 306. In embodiments, the RAN 306 may be NG-RAN, E-UTRAN, etc. The UE 302 and UE 304 utilize connections (or channels) (shown as connection 308 and connection 310, respectively) with the RAN 306, each of which comprises a physical communications interface. The RAN 306 can include one or more base stations (such as base station 312 and base station 314) that enable the connection 308 and connection 310.

In this example, the connection 308 and connection 310 are air interfaces to enable such communicative coupling, and may be consistent with RAT(s) used by the RAN 306, such as, for example, an LTE and/or NR.

In some embodiments, the UE 302 and UE 304 may also directly exchange communication data via a sidelink interface 316. The UE 304 is shown to be configured to access an access point (shown as AP 318) via connection 320. By way of example, the connection 320 can comprise a local wireless connection, such as a connection consistent with any IEEE 802.11 protocol, wherein the AP 318 may comprise a Wi-Fi^{®}router. In this example, the AP 318 may be connected to another network (for example, the Internet) without going through a CN 324.

In embodiments, the UE 302 and UE 304 can be configured to communicate using orthogonal frequency division multiplexing (OFDM) communication signals with each other or with the base station 312 and/or the base station 314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 312 or base station 314 may be implemented as one or more software entities running on server computers as part of a virtual network. In addition, or in other embodiments, the base station 312 or base station 314 may be configured to communicate with one another via interface 322. In embodiments where the wireless communication system 300 is an LTE system (e.g., when the CN 324 is an EPC), the interface 322 may be an X2 interface. The X2 interface may be defined between two or more base stations (e.g., two or more eNBs and the like) that connect to an EPC, and/or between two eNBs connecting to the EPC. In embodiments where the wireless communication system 300 is an NR system (e.g., when CN 324 is a 5GC), the interface 322 may be an Xn interface. The Xn interface is defined between two or more base stations (e.g., two or more gNBs and the like) that connect to 5GC, between a base station 312 (e.g., a gNB) connecting to 5GC and an eNB, and/or between two eNBs connecting to 5GC (e.g., CN 324).

The RAN 306 is shown to be communicatively coupled to the CN 324. The CN 324 may comprise one or more network elements 326, which are configured to offer various data and telecommunications services to customers/subscribers (e.g., users of UE 302 and UE 304) who are connected to the CN 324 via the RAN 306. The components of the CN 324 may be implemented in one physical device or separate physical devices including components to read and execute instructions from a machine-readable or computer-readable medium (e.g., a non-transitory machine-readable storage medium).

In embodiments, the CN 324 may be an EPC, and the RAN 306 may be connected with the CN 324 via an S1 interface 328. In embodiments, the S1 interface 328 may be split into two parts, an S1 user plane (S1-U) interface, which carries traffic data between the base station 312 or base station 314 and a serving gateway (S-GW), and the S1-MME interface, which is a signaling interface between the base station 312 or base station 314 and mobility management entities (MMEs).

In embodiments, the CN 324 may be a 5GC, and the RAN 306 may be connected with the CN 324 via an NG interface 328. In embodiments, the NG interface 328 may be split into two parts, an NG user plane (NG-U) interface, which carries traffic data between the base station 312 or base station 314 and a user plane function (UPF), and the S1 control plane (NG-C) interface, which is a signaling interface between the base station 312 or base station 314 and access and mobility management functions (AMFs).

Generally, an application server 330 may be an element offering applications that use internet protocol (IP) bearer resources with the CN 324 (e.g., packet switched data services). The application server 330 can also be configured to support one or more communication services (e.g., VoIP sessions, group communication sessions, etc.) for the UE 302 and UE 304 via the CN 324. The application server 330 may communicate with the CN 324 through an IP communications interface 332.

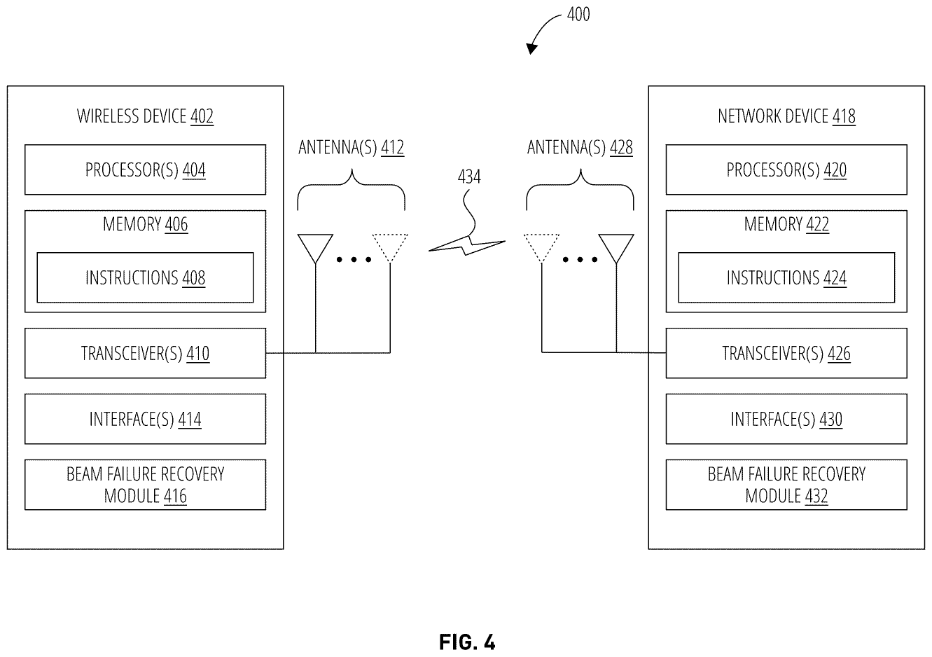

FIG. 4 illustrates a system 400 for performing signaling 434 between a wireless device 402 and a network device 418, according to embodiments disclosed herein. The system 400 may be a portion of a wireless communications system as herein described. The wireless device 402 may be, for example, a UE of a wireless communication system. The network device 418 may be, for example, a base station (e.g., an eNB or a gNB) of a wireless communication system.

The wireless device 402 may include one or more processor(s) 404. The processor(s) 404 may execute instructions such that various operations of the wireless device 402 are performed, as described herein. The processor(s) 404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 402 may include a memory 406. The memory 406 may be a non-transitory computer-readable storage medium that stores instructions 408 (which may include, for example, the instructions being executed by the processor(s) 404). The instructions 408 may also be referred to as program code or a computer program. The memory 406 may also store data used by, and results computed by, the processor(s) 404.

The wireless device 402 may include one or more transceiver(s) 410 that may include radio frequency (RF) transmitter circuitry and/or receiver circuitry that use the antenna(s) 412 of the wireless device 402 to facilitate signaling (e.g., the signaling 434) to and/or from the wireless device 402 with other devices (e.g., the network device 418) according to corresponding RATs.

The wireless device 402 may include one or more antenna(s) 412 (e.g., one, two, four, or more). For embodiments with multiple antenna(s) 412, the wireless device 402 may leverage the spatial diversity of such multiple antenna(s) 412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 402 may be accomplished according to precoding (or digital beamforming) that is applied at the wireless device 402 that multiplexes the data streams across the antenna(s) 412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 402 may implement analog beamforming techniques, whereby phases of the signals sent by the antenna(s) 412 are relatively adjusted such that the (joint) transmission of the antenna(s) 412 can be directed (this is sometimes referred to as beam steering).

The wireless device 402 may include one or more interface(s) 414. The interface(s) 414 may be used to provide input to or output from the wireless device 402. For example, a wireless device 402 that is a UE may include interface(s) 414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 410/antenna(s) 412 already described) that allow for communication between the UE and other devices and may operate according to known protocols (e.g., Wi-Fi®, Bluetooth®, and the like).

The wireless device 402 may include a beam failure recovery module 416. The beam failure recovery module 416 may be implemented via hardware, software, or combinations thereof. For example, the beam failure recovery module 416 may be implemented as a processor, circuit, and/or instructions 408 stored in the memory 406 and executed by the processor(s) 404. In some examples, the beam failure recovery module 416 may be integrated within the processor(s) 404 and/or the transceiver(s) 410. For example, the beam failure recovery module 416 may be implemented by a combination of software components (e.g., executed by a DSP or a general processor) and hardware components (e.g., logic gates and circuitry) within the processor(s) 404 or the transceiver(s) 410.

The beam failure recovery module 416 may be used for various aspects of the present disclosure, for example, aspects of FIG. 1 and FIG. 2. The beam failure recovery module 416 may configure the wireless device 402 to generate active TCI state metrics corresponding to an active TCI state and non-active TCI state metrics corresponding to a plurality of non-active TCI states based on measurements performed on reference signals and SSBs received from a base station at a first time period. The beam failure recovery module 416 may further configure the wireless device 402 to select a target TCI state based, in part, on comparing the active TCI state metrics and the non-active TCI state metrics. The beam failure recovery module 416 may further configure the wireless device 402 to determine that the active TCI state metrics is less than a maximum metric value. The beam failure recovery module 416 may further configure the wireless device 402 to, in response to the active TCI state metrics being less than the maximum metric value, proactively triggering, at the UE, BFR to switch from the active TCI state to the target TCI state without receiving TCI state configuration signaling from the base station.

The network device 418 may include one or more processor(s) 420. The processor(s) 420 may execute instructions such that various operations of the network device 418 are performed, as described herein. The processor(s) 420 may include one or more baseband processors implemented using, for example, a CPU, a DSP, an ASIC, a controller, an FPGA device, another hardware device, a firmware device, or any combination thereof configured to perform the operations described herein.

The network device 418 may include a memory 422. The memory 422 may be a non-transitory computer-readable storage medium that stores instructions 424 (which may include, for example, the instructions being executed by the processor(s) 420). The instructions 424 may also be referred to as program code or a computer program. The memory 422 may also store data used by, and results computed by, the processor(s) 420.

The network device 418 may include one or more transceiver(s) 426 that may include RF transmitter circuitry and/or receiver circuitry that use the antenna(s) 428 of the network device 418 to facilitate signaling (e.g., the signaling 434) to and/or from the network device 418 with other devices (e.g., the wireless device 402) according to corresponding RATs.

The network device 418 may include one or more antenna(s) 428 (e.g., one, two, four, or more). In embodiments having multiple antenna(s) 428, the network device 418 may perform MIMO, digital beamforming, analog beamforming, beam steering, etc., as has been described.

The network device 418 may include one or more interface(s) 430. The interface(s) 430 may be used to provide input to or output from the network device 418. For example, a network device 418 that is a base station may include interface(s) 430 made up of transmitters, receivers, and other circuitry (e.g., other than the transceiver(s) 426/antenna(s) 428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 418 may include a beam failure recovery module 432. The beam failure recovery module 432 may be implemented via hardware, software, or combinations thereof. For example, the beam failure recovery module 432 may be implemented as a processor, circuit, and/or instructions 424 stored in the memory 422 and executed by the processor(s) 420. In some examples, the beam failure recovery module 432 may be integrated within the processor(s) 420 and/or the transceiver(s) 426. For example, the beam failure recovery module 432 may be implemented by a combination of software components (e.g., executed by a DSP or a general processor) and hardware components (e.g., logic gates and circuitry) within the processor(s) 420 or the transceiver(s) 426.

The beam failure recovery module 432 may be used for various aspects of the present disclosure, for example, aspects of FIG. 1. The beam failure recovery module 432 may configure the network device 418 to perform any of the network-based methods discussed herein.

Embodiments contemplated herein include an apparatus comprising means to perform one or more elements of the method 200. This apparatus may be, for example, an apparatus of a UE (such as a wireless device 402 that is a UE, as described herein).

Embodiments contemplated herein include one or more non-transitory computer-readable media comprising instructions to cause an electronic device, upon execution of the instructions by one or more processors of the electronic device, to perform one or more elements of the method 200. This non-transitory computer-readable media may be, for example, a memory of a UE (such as a memory 406 of a wireless device 402 that is a UE, as described herein).

Embodiments contemplated herein include an apparatus comprising logic, modules, or circuitry to perform one or more elements of the method 200. This apparatus may be, for example, an apparatus of a UE (such as a wireless device 402 that is a UE, as described herein).

Embodiments contemplated herein include an apparatus comprising: one or more processors and one or more computer-readable media comprising instructions that, when executed by the one or more processors, cause the one or more processors to perform one or more elements of the method 200. This apparatus may be, for example, an apparatus of a UE (such as a wireless device 402 that is a UE, as described herein).

Embodiments contemplated herein include a signal as described in or related to one or more elements of the method 200.

Embodiments contemplated herein include a computer program or computer program product comprising instructions, wherein execution of the program by a processor is to cause the processor to carry out one or more elements of the method 200. The processor may be a processor of a UE (such as a processor(s) 404 of a wireless device 402 that is a UE, as described herein). These instructions may be, for example, located in the processor and/or on a memory of the UE (such as a memory 406 of a wireless device 402 that is a UE, as described herein).

Embodiments contemplated herein include an apparatus comprising means to perform one or more elements of any of the network-based methods discussed herein. This apparatus may be, for example, an apparatus of a base station (such as a network device 418 that is a base station, as described herein).

Embodiments contemplated herein include one or more non-transitory computer-readable media comprising instructions to cause an electronic device, upon execution of the instructions by one or more processors of the electronic device, to perform one or more elements of any of the network-based methods discussed herein. This non-transitory computer-readable media may be, for example, a memory of a base station (such as a memory 422 of a network device 418 that is a base station, as described herein).

Embodiments contemplated herein include an apparatus comprising logic, modules, or circuitry to perform one or more elements of any of the network-based methods discussed herein. This apparatus may be, for example, an apparatus of a base station (such as a network device 418 that is a base station, as described herein).

Embodiments contemplated herein include an apparatus comprising: one or more processors and one or more computer-readable media comprising instructions that, when executed by the one or more processors, cause the one or more processors to perform one or more elements of any of the network-based methods discussed herein. This apparatus may be, for example, an apparatus of a base station (such as a network device 418 that is a base station, as described herein).

Embodiments contemplated herein include a signal as described in or related to one or more elements of any of the network-based methods discussed herein.

Embodiments contemplated herein include a computer program or computer program product comprising instructions, wherein execution of the program by a processing element is to cause the processing element to carry out one or more elements of any of the network-based methods discussed herein. The processor may be a processor of a base station (such as a processor(s) 420 of a network device 418 that is a base station, as described herein). These instructions may be, for example, located in the processor and/or on a memory of the base station (such as a memory 422 of a network device 418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
generating active transmission configuration indication (TCI) state metrics corresponding to an active TCI state, and non-active TCI state metrics corresponding to a plurality of non-active TCI states based on measurements performed on reference signals and synchronization signal blocks (SSBs) received from a base station at a first time period;
selecting a target TCI state based, in part, on comparing the active TCI state metrics and the non-active TCI state metrics;
determining that the active TCI state metrics are less than a maximum metric value; and
in response to the active TCI state metrics being less than the maximum metric value, triggering, at the UE, beam failure recovery (BFR) to switch from the active TCI state to the target TCI state before receiving TCI state configuration signaling from the base station.

2. The method of claim 1, further comprising:
generating updated active TCI state metrics and updated non-active TCI state metrics based on measurements performed according to the target TCI state on the reference signals and the SSBs received from the base station at a second time period.

3. The method of claim 1, wherein selecting the target TCI state comprises:
in response to at least one of the non-active TCI state metrics being greater than the active TCI state metrics, selecting a strongest non-active TCI state of the plurality of non-active TCI states corresponding to the non-active TCI state metrics as the target TCI state.

4. The method of claim 1, wherein the maximum metric value comprises a maximum reference signal received power (RSRP) value or a maximum signal-to-interference-plus noise ratio (SINR).

5. The method of claim 1, wherein the active TCI state metrics comprise a reference signal received power (RSRP) value and a signal-to-interference-plus noise ratio (SINR).

6. The method of claim 1, wherein the non-active TCI state metrics comprise a reference signal received power (RSRP) value and a signal-to-interference-plus noise ratio (SINR).

7. The method of claim 1, wherein after triggering the BFR the active TCI state comprises an implicit TCI state, the method further comprising receiving, from the base station, a medium access control control element (MAC CE) message activating the implicit TCI state.

8. The method of claim 7, wherein the implicit TCI state is determined by the UE according to the measurements performed on the reference signals and the SSBs.

9. The method of claim 1, further comprising performing beam failure detection (BFD) based on a block error rate (BLER) threshold crossing and the active TCI state metrics.

10. An apparatus comprising:
a memory to store measurements performed on reference signals and synchronization signal blocks (SSBs) received from a base station at a first time period; and
one or more processors configured to:
generate active transmission configuration indication (TCI) state metrics corresponding to an active TCI state and non-active TCI state metrics corresponding to a plurality of non-active TCI states based on the measurements performed on the reference signals and the SSBs received from the base station at the first time period;
select a target TCI state based, in part, on comparing the active TCI state metrics and the non-active TCI state metrics;
determine that the active TCI state metrics are less than a maximum metric value; and
in response to the active TCI state metrics being less than the maximum metric value, trigger, at the apparatus, beam failure recovery (BFR) to switch from the active TCI state to the target TCI state before receiving TCI state configuration signaling from the base station.

11. The apparatus of claim 10, wherein the one or more processors are further configured to generate updated active TCI state metrics and updated non-active TCI state metrics based on measurements performed according to the target TCI state on the reference signals and the SSBs received from the base station at a second time period.

12. The apparatus of claim 10, wherein the one or more processors configured to select the target TCI state are further configured to:
in response to at least one of the non-active TCI state metrics being greater than the active TCI state metrics, select a strongest non-active TCI state of the plurality of non-active TCI states corresponding to the non-active TCI state metrics as the target TCI state.

13. The apparatus of claim 10, wherein the maximum metric value comprises a maximum reference signal received power (RSRP) value or a maximum signal-to-interference-plus noise ratio (SINR).

14. The apparatus of claim 10, wherein the active TCI state metrics comprise a reference signal received power (RSRP) value and a signal-to-interference-plus noise ratio (SINR).

15. The apparatus of claim 10, wherein the non-active TCI state metrics comprise a reference signal received power (RSRP) value and a signal-to-interference-plus noise ratio (SINR).

16. The apparatus of claim 10, wherein after triggering the BFR the active TCI state comprises an implicit TCI state, the one or more processors further configured to receive, from the base station, a medium access control control element (MAC CE) message activating the implicit TCI state.

17. The apparatus of claim 16, wherein the implicit TCI state is determined by the apparatus according to the measurements performed on the reference signals and the SSBs.

18. The apparatus of claim 10, wherein the one or more processors are further configured to perform beam failure detection (BFD) based on a block error rate (BLER) threshold crossing and the active TCI state metrics.

19. At least one non-transitory computer-readable medium carrying instructions that, when executed by at least one processor of a user equipment (UE), cause the UE to:
generate active transmission configuration indication (TCI) state metrics corresponding to an active TCI state and non-active TCI state metrics corresponding to a plurality of non-active TCI states based on measurements performed on reference signals and synchronization signal blocks (SSBs) received from a base station at a first time period;
select a target TCI state based, in part, on comparing the active TCI state metrics and the non-active TCI state metrics;
determine that the active TCI state metrics are less than a maximum metric value; and
in response to the active TCI state metrics being less than the maximum metric value, trigger, at the UE, beam failure recovery (BFR) to switch from the active TCI state to the target TCI state before receiving TCI state configuration signaling from the base station.

20. The non-transitory computer-readable medium of claim 19, wherein the instructions that, when executed by the at least one processor of the UE, further cause the UE to generate updated active TCI state metrics and updated non-active TCI state metrics based on measurements performed according to the target TCI state on the reference signals and the SSBs received from the base station at a second time period.
